(19) United States
(12) Patent Application Publication
(10) Pub. No.: US 2019/0318367 A1
(43) Pub. Date: Oct. 17, 2019

(54) MERCHANT SERVICES CONTRACT-ANALYSIS AND SALES-FACILITATION SYSTEM, SOFTWARE, COMPONENTS, AND METHODS

(71) Applicant: Rose Through Concrete, LLC, Fresno, CA (US)

(72) Inventor: Stephen J. Myles, Fresno, CA (US)

(21) Appl. No.: 16/432,717

(22) Filed: Jun. 5, 2019

Related U.S. Application Data
(63) Continuation-in-part of application No. 16/244,731, filed on Jan. 10, 2019.
(60) Provisional application No. 62/818,047, filed on Mar. 13, 2019.
(60) Provisional application No. 62/615,636, filed on Jan. 10, 2018.

(51) Int. Cl. G06Q 30/02; G06Q 10/06

(52) U.S. Cl. CPC G06Q 30/0201; G06Q 10/0637; G06Q 30/0281

(57) ABSTRACT

Systems, processes, and methods for analyzing merchant services provider data and for facilitating sales and customer relationships between a merchant and merchant services provider. Such features are incorporated into software, which may downloaded and accessed on a computing device, such as a smartphone or tablet, which allows a user to extract data from merchant services providers to compute metrics, statistics, and other useful information. The software also allows a user to retrieve information about merchant services providers and enables a user and a prospective merchant services provider to interact electronically or in-person.

### CROSS-REFERENCE TO RELATED APPLICATIONS

The present application is a continuation-in-part of pending U.S. Nonprovisional patent application Ser. No. 16/244,731, filed Jan. 10, 2019, which claims priority to, and the benefit of, U.S. Provisional Patent Application No. 62/615,636, filed on Jan. 10, 2018, each of which are hereby incorporated by reference in their entirety. The present application also claims priority to, and the benefit of, U.S. Provisional Patent Application No. 62/818,047, filed on Mar. 13, 2019, which is hereby incorporated by reference in its entirety.

### FIELD OF THE INVENTION

Various embodiments of the invention relate to automated and semi-automated merchant services data collection, mining, and analysis, and sales facilitation. The present invention also concerns customer relationship management and monitoring systems, particularly as applied to merchants and merchant services providers.

### BACKGROUND OF THE INVENTION

Merchant services is a competitive multi-billion dollar industry involving sales and provisions of financial services to merchants. A seminal example of such services is credit or debit card processing services, which a merchant purchases to allow the merchant to accept credit or debit card payments from its customers, using real or virtual point-of-sale systems. The services are typically sold via sales representatives that approach the merchant in person, by phone, through mailer, and other telecommunications to discuss the services. Since many merchants already have existing service contracts with other providers, a key aspect of these sales calls is a comparison of current service contracts and associated fees with those offered by sales provider.

There exists at least one problem with conventional interactions. In particular, many merchants are unfamiliar with all of the terms, details, and fees of their current service contracts, and that weighing the pros and cons of the relatively familiar to the newly proposed ones are cumbersome and time-consuming, leading some merchants to avoid these types of sales calls altogether. This means that many merchants miss out on opportunities to save money or reap other rewards from more advantageous and merchant-friendly service contracts.

Accordingly, there exists a need for a better way for merchants and merchant services provider sales agents to interact and communicate with one another. Furthermore, there exists a need for a means by which merchants can (i) characterize their current relationship with their merchant services provider and (ii) obtain transparency regarding the contract terms offered by various merchant services providers. The present invention concerns systems, processes, and methods related to merchant services activities to address one or more problems with conventional processes.

### BRIEF SUMMARY OF THE INVENTION

According the some embodiments of the present invention, methods are provided for establishing relationships between merchants and merchant services providers. In particular, disclosed are methods by which merchant services providers, within a merchant's area or region, can be identified to the merchant. In some embodiments, potential merchant services providers may be identified based on a comparison between i) data collected and computed from the contract terms of a merchant's current merchant services provider and ii) data collected and computed from the contract terms of one or more potential merchant services providers.

To facilitate establishing relationships between merchants and merchant services providers, in some embodiments of the present invention, at least one server may provide software which may be in the form of one or more applications that can be downloaded to one or more types of computing devices, such as smartphone or tablet computer. The software may be configured for an individual or business, but preferably for a target market of small and medium sized business merchants and merchant services providers. The software may be downloaded and used by merchant business owners or merchant services provider account representatives, as well as employees and personnel associated therewith. In some embodiments, information may be collected or extracted from data provided by the merchant and merchant services provider (or from a third-party platform) which can be utilized by the software to search for, or suggest, new or alternative merchant services providers to the merchant.

In accordance with some embodiments of the present invention, a system network may be provided for facilitating and carrying out functions of the software, including one or more databases, one or more servers, and one or more client computing devices (e.g., smartphone, tablet, computer, etc.) which may be coupled in a wide- or local-area network. In some embodiments, a database, which may include public and/or private information, may be coupled with a server to enable the exchange of data therebetween. A server may include one or more memory devices for storing public and/or private data, along with machine-executable instructions. A server may also include one or more processors for reading machine-executable instructions in order to carry out, or otherwise facilitate, one or more aspects of the invention(s) described herein.

In some embodiments of the present invention, a system network may integrate algorithms, machine learning techniques, bots, artificial intelligence (“AI”), data capture and analysis techniques, and/or cyber security practices. For example, one or more algorithms may be used to compute rates and fees charged by a merchant services provider, or to determine, identify, or classify types of transactions. In some embodiments, one or more algorithms may be used to calculate metrics related to use or allocation of funds.

In some embodiments, machine learning techniques may be employed in order to provide a more individualized experience for software users. For example, machine learning may be used to provide suggestions or tips to a user to help both merchants and merchant services providers network and reach their customer base. In some embodiments, bots, AI, or machine learning, and combinations thereof, may be used to extract and provide third-party data, information, and services to software users.

In some embodiments of the present invention, software may be adapted to be integrated with third-party software and platforms to allow for data exchange therebetween. For example, the software may be integrated with third-party credit monitoring services to obtain credit information which can be used in building user financial profiles. To safely and securely store sensitive information and exchange information with third-party software and platforms, various cyber security and encryption techniques may be utilized.

In some implementations of the present invention, a method may be provided for facilitating relationships between merchants and merchant services providers, which may comprise the steps of: (i) receiving information about a current relationship between a merchant and a current merchant services provider; (ii) characterizing the current relationship, which may comprise computing a current effective rate from the information received about the current relationship; (iii) receiving information about a potential relationship between the merchant and a potential merchant services provider; (iv) characterizing the potential relationship between the merchant and the potential merchant services provider, which may comprise computing a potential effective rate from the information received about the potential relationship; (v) comparing the current relationship and the potential relationship, which may comprise comparing the current effective rate and the potential effective rate; (vi) if the potential effective rate is lower than the current effective rate, providing a recommendation to the merchant to contact the potential merchant services provider and facilitating an initial communication between the merchant and the potential merchant services provider.

In some embodiments, the information received about the current relationship may comprise at least one term of a contract between the merchant and the current merchant services provider. A term of the contract may include processing fees charged, processing rates charged, service fees charged, or interchange fees charged by the current merchant services provider, or combinations thereof. Similarly, in some embodiments, the information received about the potential relationship may comprise at least one term of a potential contract between the merchant and the potential merchant services provider. A term of the potential contract may include processing fees charged, processing rates charged, service fees charged, or interchange fees charged by the potential merchant services provider, or combinations thereof.

In some embodiments, the information received about the current relationship may comprise transactional use data from at least one statement issued by the current merchant services provider to the merchant. Transactional use data may comprise payment transactions by payment card type, third-party transactions, chargebacks, reversals, adjustments, fees charged, amount funded, average ticket by payment card type, or pending charges, or combinations thereof. In some embodiments, characterizing the current relationship between the merchant and the current merchant services provider may comprise computing at least one use metric from transactional use data. A use metric may include the effective rate charged by the merchant services provider, the average ticket amount by payment card type, the total amount of fees charged by the merchant services provider, or the total amount of pending charges and fees, or combinations thereof.

In accordance with some embodiments of the present invention, a computer implemented method may be provided for operating one or more servers which may be used to establish a communication with a merchant, which may comprise a series of steps. A first step may comprise maintaining a merchant services provider database in a memory resource associated with the servers, wherein the merchant services provider database may comprise a plurality of entries. Each entry may correspond to one of a plurality of potential merchant services providers and may comprise: (i) an identification of the corresponding potential merchant services provider; (ii) an identification of a representative of the corresponding potential merchant services provider; (iii) an identification of a geographic area associated with the corresponding potential merchant services provider; and (iv) at least one term of a contract offered by the corresponding potential merchant services provider.

A second step may comprise receiving, from a merchant application executing on a computing device of the merchant: (i) information about a relationship between the merchant and a current merchant services provider, and (ii) a location associated with the merchant. In some implementations, receiving the location associated with the merchant may comprise receiving the current location of the merchant computing device, based on data determined by the merchant application executing to interface with a Global Positioning System resource of the merchant computing device. In other implementations, the location associated with the merchant may be received based on a form generated by the merchant application. In some embodiments, the step of receiving a location associated with the merchant may also comprise receiving a location radius, which may be based on a form generated by the merchant application.

In some implementations, the step of receiving, from a merchant application executing on a computing device of the merchant, information about a relationship between the merchant and a current merchant services provider may comprise receiving at least one image based on data determined by the merchant application executing to interface with a camera resource of the merchant computing device. In some aspects, an image may correspond to a statement issued by the current merchant services provider and additional step may be executed comprising processing the image to extract transactional use data therefrom. Transactional use data may include accounting information such as, but not limited to, transactions by payment card type, third-party transactions, chargebacks, reversals, adjustments, fees charged, amount funded, average ticket by payment card type, or pending charges, or combinations thereof.

In some implementations, the step of receiving, from a merchant application, information about the current merchant services provider relationship may comprise receiving at least one contract term of a contract between the merchant and the current merchant services provider based on a form generated by said merchant application. In some embodiments, a contract term may include current merchant services provider information such as, but not limited to, processing fees charged, processing rates charged, service fees charged, and interchange fees charged. From one or more contract terms, the current effective rate of the current merchant services provider may be computed.

A third step may comprise computing a current effective rate from the current merchant services provider relationship information. In some embodiments, the current effective rate may be computed from transactional use data.

A fourth step may comprise generating a candidate list of potential merchant services providers from the merchant services provider database. In some implementations, the step of generating the candidate list may further include the steps of: (i) determining which of the potential merchant services providers have a geographic area which encompasses the location associated with the merchant; (ii) computing a potential effective rate for at least one of the potential merchant services providers; and (iii) determining which of the potential merchant services providers have a potential effective rate which is less than the current effective rate of the current merchant services provider. In some embodiments, computing a potential effective rate may include the steps of: (i) processing at least one image received by the merchant application, wherein the image may be based on data determined by the merchant application executing to interface with a camera resource of the merchant computing device, to extract transactional use data; and (ii) computing the potential effective rate from transactional use data and at least one term of the contract offered by the potential merchant services provider.

A fifth step may comprise providing data to the merchant application to generate a presentation on a display of the merchant computing device, wherein the presentation may comprise the candidate list.

A sixth step may comprise receiving, from the merchant application, a request to establish a communication with a selected potential merchant services provider from the candidate list.

A seventh step may comprise providing data to a merchant services provider application executing on a computing device of the representative of the selected potential merchant services provider to generate a presentation on a display of the representative computing device, wherein the presentation may comprise the request to establish the communication with the merchant.

An eighth step may comprise receiving data from the merchant services provider application, which may comprise an acceptance of the request to establish the communication with the merchant.

In some implementations, the step of receiving data from the merchant services provider application may be followed by the steps of: i) providing data to the merchant application to generate a presentation on a display of the merchant computing device, wherein the presentation which may comprise a list of times that the communication may be established; ii) receiving from the merchant application a selected communication time; iii) providing data to the merchant services provider application to generate a presentation on a display of the representative computing device, wherein the presentation which may comprise the selected communication time; iv) receiving from the merchant services provider application an acceptance of the selected communication time; and v) providing data to the merchant application confirming the selected communication time.

In some implementations, the step of providing data to the merchant application confirming the selected communication time may be followed by the steps of: vi) providing data to the merchant application to generate a presentation on a display of the merchant computing device, wherein the display may comprise a chat box; and vii) providing data to the merchant services provider to generate a presentation on a display of the representative computing device, wherein the display may comprise a chat box. In certain implementation, the step of providing data to the merchant services provider may be followed by viii) receiving data from the merchant application and providing the data to the merchant services provider application, wherein the data may comprise a message from the merchant to the merchant services provider representative; and ix) receiving data from the merchant services provider application and providing the data to the merchant application, wherein the data may comprise a message from the merchant services provider representative to the merchant.

In other implementations, the step of providing data to the merchant application confirming the selected communication time may be followed by the steps of: vi) providing data to the merchant application to create an entry in a calendar application executing on the merchant computing device; and vii) providing data to the merchant services provider application to create an entry in a calendar application executing on the representative computing device.

In accordance with some embodiments of the present invention, a merchant services provider contract monitoring service system is provided. In some embodiments, the system may comprise one or more processors which may be coupled to a non-transient storage media which may store instructions for causing one or more processors to: i) receive current relationship data from a merchant application executing on a computing device of a merchant, wherein the data may comprise information about a relationship between the merchant and a current merchant services provider; ii) analyze the current relationship data received by the merchant application to compute a current effective rate, wherein the current effective rate may comprise a ratio of the dollar amount assessed by the current merchant services provider to the dollar amount of transactions submitted for processing; iii) simulate a potential relationship between the merchant and a potential merchant services provider, which may comprise computing a potential effective rate from the current relationship data and one or more terms of a contract offered by the potential merchant services provider; iv) compare the current effective rate and the potential effective rate; and v) if the potential effective rate is less than the current effective rate, establish a communication between the merchant computing device and a representative computing device of a representative of the potential merchant services provider.

In some implementations of a merchant services provider contract monitoring service system, the step of receiving current relationship data may comprise: (i) receiving at least one image which may be based on data determined by the merchant application executing to interface with a camera resource of the merchant computing device; and (ii) processing the image(s) to extract transactional use data therefrom.

In some implementations of a merchant services provider contract monitoring service system, the step of establishing communication may comprise the steps of: (i) first, providing data to the merchant application, wherein the data may comprise the potential effective rate and an identification of the potential merchant services provider; (ii) then, receiving data from the merchant application, wherein the data may comprise a request to establish the communication between the merchant and the potential merchant services provider; (iii) then, providing data to a merchant services provider application executing on a computing device of a representative of the potential merchant services provider, wherein the data may comprise a request to accept the request to establish the communication; (iv) then, receiving data from the merchant services provider application, wherein the data may comprise an acceptance of the request to accept the request to establish the communication; and (v) then, providing data to the merchant application, wherein the data may comprise an acceptance of the request to establish the communication.

In some implementations of a merchant services provider contract monitoring service system, the step of establishing communication may comprise receiving from, and providing data to, each the merchant application and the merchant services provider application, wherein the data may comprise (i) messages received by the merchant application executing to interface with a merchant user input of the merchant computing device and (ii) messages received by the merchant services provider application executing to interface with a merchant services provider user input of the representative computing device.

### BRIEF DESCRIPTION OF THE DRAWINGS

FIG. 1 is a flowchart illustrating the steps of an exemplary method in accordance with some embodiments of the present invention.

FIG. 2 is a swim lane diagram illustrating the steps in an exemplary software process in accordance with some embodiments of the present invention.

FIG. 3 is a diagram illustrating an exemplary system for implementing software in accordance with some embodiments of the present invention.

### DETAILED DESCRIPTION OF THE INVENTION

The invention, in its various aspects, will be explained in greater detail below. While the invention will be described in conjunction with several exemplary embodiments, the exemplary embodiments themselves do not limit the scope of the invention. Similarly, the exemplary illustrations in the accompanying drawings, where like elements have like numerals, do not limit the scope of the exemplary embodiments and/or invention, including any length, angles, or other measurements provided. Rather the invention, as defined by the claims, may cover alternatives, modifications, and/or equivalents of the exemplary embodiments.

### Exemplary Method for Facilitating Relationships

According to some embodiments of the present invention, methods are provided for establishing and facilitating relationships between merchants and a merchant services providers (sometimes referred to herein as “MSPs”). In preferred embodiments, methods are provided to identify MSPs within a merchant's area or region and to facilitate communication between them—either for the purpose of finding a new merchant services provider (e.g., for new businesses), or for replacing the merchant's current merchant services provider. For example, based on a merchant's location and financial information relating to their current MSP, one or more potential MSPs can be determined (e.g., MSPs with lower rates, lower fees, flexible contract terms, high transaction volume capabilities, etc.).

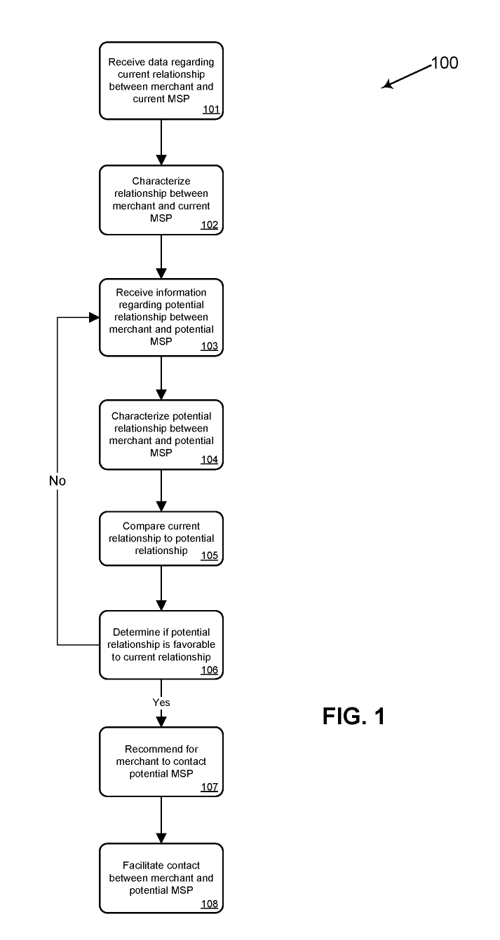

Referring to FIG. 1, an exemplary method 100 of facilitating a relationship between a merchant and a merchant services provider is illustrated. Step 101 may comprise receiving information regarding the current relationship between a merchant and the merchant's current

MSP. This may include information regarding the terms of a contract between the merchant and their current MSP and/or transactional data associated with the relationship. In some embodiments, transactional data may be obtained from a merchant account statement issued by the merchant's current MSP.

Step 102 may comprise characterizing the relationship between the merchant and their current MSP. This may include computing a value, or use metric, from the current contract term data and/or transactional data, which may be used to characterize the current relationship in terms of a quantity. In some implementations, such computed information may include, but not limited to, effective rate, average number or amount of transactions, average ticket, fees charged and/or pending, and projected annual volume.

Step 103 may comprise receiving information regarding a potential relationship between the merchant and a potential MSP. In some implementations, step 103 may comprise determining the merchant's location and identifying the potential MSP based on the merchant's location and the computed value or metric from step 102.

Step 104 may comprise characterizing the potential relationship between the merchant and the potential MSP. In some implementations, this may include receiving data regarding the potential contract terms of the potential MSP and then calculating a value, or use metric, based on the potential contract term data. In some embodiments, transactional data from the merchant's account statement may be used in projecting values or metrics. For example, a projected, or potential, effective rate may be calculated by combining the potential contract term data with transactional data from a merchant's account statement.

Step 105 may comprise comparing the current relationship to the potential relationship. This may include a comparison between a value or use metric calculated in step 102 and a value or use metric calculated in step 104. In some implementations, this may include a direct comparison between the effective rate charged by the current MSP and the projected effective rate charged by the potential MSP. In other implementations, values or metrics calculated during steps 102 and/or 104 may be used to calculate another value or metric. For example, and without limitation, the projected effective rate charged by the potential MSP may be used to calculate a projected average monthly savings, or a savings amount over a prior period of time, based on transactional data provided by one or more merchant account statements.

Based on the comparison executed in step 105, step 106 may comprise determining whether the potential relationship with the potential MSP is more favorable than the merchant's relationship with their current MSP. For example, a potential MSP may be considered to be favorable over a merchant's current MSP, if a relationship with the potential MSP yields significant savings, either on a long-term or short-term basis.

If the potential relationship between the merchant and the potential MSP is found to be favorable, step 106 may be followed by step 107 comprising providing a recommendation to the merchant to contact, or set an appointment with, the potential MSP. If the potential relationship is found not to be favorable, step 107 may be followed by returning to step 103 in which information is received regarding a potential relationship with a new potential MSP.

Step 108 may comprise facilitating initial contact and communication between the merchant and potential MSP. For example, and without limitation, this may include providing contact information to the merchant and/or potential MSP, or setting up an appointment between the merchant and MSP.

### Exemplary Technical Process for Facilitating Relationships

According to some embodiments of the present invention, software is provided, which can be accessed on a web browser, downloaded to a mobile device (e.g., a smartphone), or downloaded to one or more servers. The software may be downloaded and used by merchants, and merchant business personnel, as well as MSP account representatives and sales professionals, or the like. In preferred embodiments of the present invention, the software may be compatible with conventional operating systems for mobile devices, such as the iOS mobile operating system of Apple Inc. and the mobile operating system ANDROID®, a registered trademark of Google LLC. The software may also be downloadable in the form of an application from mobile software distribution platforms, such as the APP STORE®, a registered trademark of Apple Inc., and GOOGLE PLAY®, a registered trademark of Google LLC, mobile software retail stores. The software can also integrate with existing features and functionality of mobile devices. In some embodiments, the software may utilize information collected or extracted from data provided by a merchant or MSP (or a third-party platform) to search for, or suggest, new or alternative MSPs to the merchant.

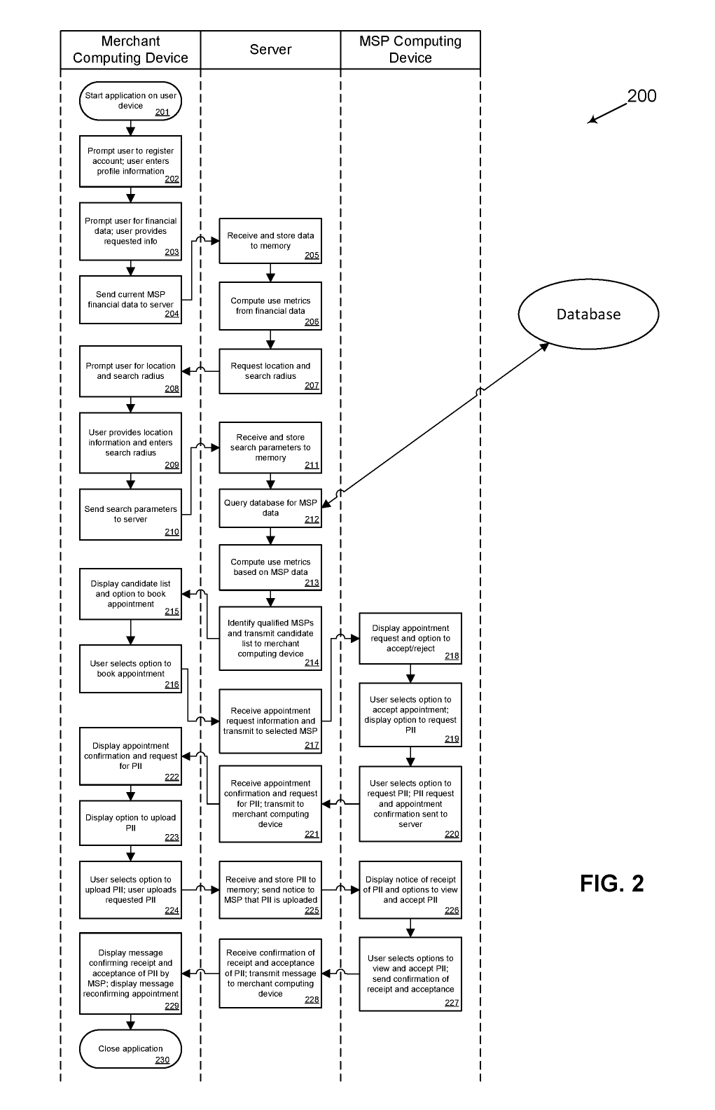

In general, the processes and steps involved in characterizing and establishing relationships between merchants and service providers may be embodied in the software. More particularly, the software may be executed, or implemented, by a computer, facilitating the exchange of data and information between user devices, servers, and databases. For example, FIG. 2 illustrates an exemplary process 200 of establishing communication between a merchant and an MSP, wherein the steps of process 200 are arranged according to the server or computing device through which the step is executed. In this exemplary illustration, the server may be representative of one or more servers and a computing device may be representative of a smartphone, tablet, laptop computer, personal computer, or the like. On the respective computing device of a merchant and MSP, an application may downloaded to provide access to the software.

### Steps 201-202

In step 201, a merchant user starts the application on their computing device (e.g., smartphone). In step 202, the user is prompted to register an account and the user enters requested personal profile information. In some embodiments, when a user creates a profile, options may be provided to generate a new profile manually, or to create a profile based off of a pre-established email account or a social networking platform account, such as FACEBOOK®, a registered trademark of Facebook, Inc., or LINKEDIN®, a registered trademark of LinkedIn Corporation, social networking platforms. If a user creates a profile using a third-party platform account, information may be able to be extracted therefrom to build the user profile.

In some implementations, step 202 may further require user identification (i.e., to specify whether the user is a merchant or service provider) in order for the application to self-configure accordingly. In some embodiments, additional options may be provided to further specify the user type. For example, and without limitation, a merchant user may further designate themselves as a business owner, manager, or employee, and an MSP user may further designate themselves as a sales manager, salesperson, or account representative. In some aspects, the features and functionality available to a user may vary between user types and sub-types. For example, a business owner may have full access to all of the merchant user features and functionality of the application, whereas an employee of the business may only have limited access to the merchant user features and functionality.

### Step 203

In step 203, the merchant user is prompted for financial information related to the user's current relationship with their MSP and the user, subsequently, enters or provides the requested information. MSP financial data may be primarily sourced from an account statement issued by the merchant's current MSP, the contract terms of the current MSP, or combinations thereof, for the purpose of characterizing the relationship between the merchant and their current service provider. In some cases, a user may be prompted to submit, or capture transactional use data from, account statements for two or more consecutive months. In some embodiments, a user may be able to enter relevant information from an account statement using an electronically fillable form. A drop-down menu, or selection list, may also be provided to allow a user to select their current MSP from a list of known providers. Based on the selected provider, some information may be automatically entered into the user's financial profile. In some embodiments, the selection list of providers can be linked to a user's geolocation to facilitate identification of relevant providers within a merchant user's area or region.

In some embodiments, a user can use a data capture feature of the software to auto-populate transactional use data. The data capture feature may refer to machine executable instructions, the associated user interface, and/or associated methodology of using associated technology and taking a photograph. For example, a user may capture an image using a digital camera on a mobile device from which the software may recognize and extract textual data, using text recognition capability, and save the data to a memory device, or cloud-based storage. The software can then store one or more portions of the captured data locally in the application, or on a server database, and in logical association with functionality. In certain embodiments, the software may include image scanning technology with integrated machine learning algorithms for better predicting data extraction from account statements.

In one implementation, a merchant user may take a picture an account statement issued by their current MSP and, from the captured image, certain types of data and information can be extracted, such as, but not limited to, current merchant processor, total amount of transactions, fees charged, and total amount funded. In some embodiments, data capture may be a function of the MSP identified, or selected, by the user, allowing for customization, normalization, or mapping of data descriptors from various MSPs to a common database structure. In some embodiments, the application may interface with conventional accounting software, such as QUICKBOOKS®, a registered trademark of Intuit Inc., accounting and bookkeeping software, to determine or audit data from an account statement, if a user provides appropriate permission and access to credentials.

### Steps 204-205

In step 204, the entered and/or extracted user data is sent to a server. In step 205, the server receives and stores the user data to memory.

### Step 206

In step 206, one or more use metrics may be computed from the merchant user's financial data. A merchant user's stored financial information (whether manually entered or automatically extracted) may be used to compute several use metrics, which may be used to i) characterize the merchant's terms with their current MSP and ii) compare the current MSP's contract terms with the contract terms of one or more potential MSPs. Some of the different use metrics which may be calculated include:
Effective rate (fees charged/total amount submitted (funded)×100);
Transactions by card type (number of transactions by card payment processor type (e.g., VISA®, a registered trademark of Visa International Service Association, MASTERCARD®, a registered trademark of MasterCard International Incorporated, AMERICAN EXPRESS®, a registered trademark of American Express Marketing & Development Corp., credit and debit card payment processors); average transaction amount; tiered averages of qualified, mid-qualified, and non-qualified transactions, etc.);
Average ticket (card type volume/card type items): “average ticket” concerns predictors for account activity, interchange fees, and risk factors—the higher the average ticket, the higher the risk may be for a merchant, the MSP, and the acquiring bank to settle or reconcile fees; this may include chargebacks and other fines or fees that may ultimately lead to merchant account closure, collections, and other negative financial implications to the merchant;
Type and total of fees charged (e.g., interchange pass through costs, such as, but not limited to: INTERLINK®, a registered trademark of Visa International Service Association, transaction fees; MAESTRO®, a registered trademark of Maestro International Incorporated, transaction fees; and regulated and unregulated transactions; fees charged by card payment security providers, such as TRANSARMOR®, a registered trademark of First Data Corporation, card payment security fees; batch settlement fees; transaction fees; authorization fees; sales discount; debit sales discount; monthly service charge; payment card industry (“PCI”) validation fees; non-receipt of PCI validation fees; decline fees; etc.);
Pending charges and fees (charges and fees not cleared by MSP); and
Projected annual volume.

In some embodiments, an algorithm may compute personalized data parameters for a merchant in order to better determine potential MSPs for the merchant. Such data may include, for example, estimated gross sales, conversion rate, MSP ratings, and statistics related to closed deals.

### Steps 207-209

In step 207, the server sends instructions to request the user's location and search radius. In step 208, on the merchant computing device, the merchant user is prompted for their location and desired search radius. In step 209, the merchant user provides location information to the application and the merchant user enters their desired search radius. In some implementations, a merchant may manually enter their location, either upon being prompted or during registration. In other implementations, a user's location can be determined automatically by obtaining the location of the user's computing device (e.g., using the GPS location of a user's mobile phone).

### Steps 210-211

In step 210, the merchant's location and search radius information are sent to the server. In step 211, the server receives and stores the merchant's location and search data.

### Step 212

In step 212, the server queries one or more databases to identify, and retrieve data for, MSPs which are within the specified radius. MSP data may be provided through publicly accessible databases (e.g., an MSP website, third-party platforms or websites containing MSP information) or through a database associated with the software. For software-associated databases, MSP data may be obtained from MSPs who are registered users of the software. For example, during registration, an MSP user may specify rates, fees, volume capabilities, and other types of information during registration, with the ability to edit this information thereafter.

### Step 213

In step 213, use metrics may be computed using (i) the transactional data obtained in step 203 and (ii) the MSP data retrieved in step 212. In some implementations, computed use metrics may be used in order to project rates and fees that would be charged under a potential MSP. For example, and without limitation, transactional data from a merchant account statement may be extrapolated and combined with data obtained for a potential MSP to calculate a projected effective rate (i.e., the effective rate the potential MSP would charge based on the same number and types of transactions posted over a period of time under the merchant's current MSP). In some implementations, an average projected savings may be determined by calculating the difference between (i) the total amount of fees charged by a merchant's current MSP over a given period of time and (ii) the total amount of fees that would have been charged by a potential MSP over the same period of time and based on the same transactional data.

It is to be appreciated that, in some embodiments, a merchant may be able to select a particular value or metric to be computed in order to compare and contrast their current MSP and an alternative MSP. A merchant may also be able to modify transactional data, or provide their own transactional parameters, to perform projections using an alternative MSP. For example, a merchant, who may currently be accepting one payment card type, may want to see how the projected effective rate for a certain MSP would change if they were to start accepting a second card type. In this case, the merchant may be able to enter an estimated number of transactions using the second card type which, in turn, can be used to calculate a new projected effective rate.

### Step 214

In step 214, a candidate list comprising potential MSPs are identified based on the computed data from step 213 and merchant's location, then the server transmits the candidate list to the merchant computing device. In some instances, no potential MSPs may be found after an initial search. As a result, in some implementations, step 214 may be followed by returning to step 209. By returning to step 209, a merchant user can increase the search radius to potentially increase the number of available MSPs in the merchant's area.

### Step 215

If one or more potential MSPs are found, step 214 may be followed by step 215, wherein the candidate list is displayed on the merchant computing device and an option to request an appointment with one of the identified MSPs is provided. In some embodiments, the type of MSP information displayed on a merchant computing device may be MSP user profiles, actual and/or effective rates, and/or projected savings.

### Step 216

In step 216, the merchant user selects the option to request an appointment with a selected MSP from the candidate list and the request is sent to the server. In some implementations, during step 216, a calendar may open (either in-application or native to the user computing device technology) showing available appointment dates and times for immediate booking. In other implementations, an option to book an appointment may only be made available if comparison between the contract terms of a merchant's current MSP and the contract terms of a potential MSP shows that there are one or more advantages to be had from the alternative MSP. If there are no advantages to be had, an alert option may be made available to notify a merchant if advantageous MSP terms become available.

In some embodiments, a messaging interface may also be concurrently executed on a merchant application and an MSP application during the appointment request step. For example, an option may be provided to open a chat box on a computing device, by which merchant personnel and MSP personnel, may exchange messages. It is to be appreciated, however, that a chat box (or other messaging interface) may be opened at other points throughout the relationship establishment process. In certain embodiments, a chat box option may be provided as a standalone feature of the application, allowing merchants and MSPs to communicate at any given time. In some embodiments, a virtual assistant, such as a chatbot, may be provided to communicate on behalf of an MSP. In certain embodiments, a chatbot may leverage a knowledge base of frequently asked questions (“FAQ”) to address the questions and concerns of merchant users. In some embodiments, a user may interact with a virtual or real financial assistant through short message service (“SMS”).

### Steps 217-218

In step 217, the server receives the appointment request and sends the request to the selected MSP. In step 218, on the computing device of the selected MSP, the appointment request is displayed along with an option to accept or reject the appointment date and/or time. In certain implementations, the selected MSP user may be able to suggest an alternative appointment date(s) and time(s) if the requested date and time does not work with the MSP user's schedule. In this case, the merchant may be presented with a notification or message indicating that the request was denied and displaying the suggested alternative date and time. The merchant may then have the option to accept the alternative appointment or request a new appointment.

### Step 219

In step 219, the MSP user selects the option to accept the appointment and an option is displayed to request personally identifiable information (“PII”) from the merchant. In some implementations, upon booking an appointment, an event may be created on the respective user's computing device calendars. An appointment confirmation email may also be sent to a merchant user regarding next steps in the process. This may include an outline of expectations for the appointment, a checklist of what to bring to the appointment, and a general reminder for the set appointment. In some embodiments, an auto-generated reminder may be set up logistically for a designated period of time prior to an appointment (e.g., 24 hours in advance) and may be sent to a user to reconfirm an appointment.

### Step 220

In step 220, the MSP user selects the option to request PII from the merchant and the PII request, along with confirmation that the appointment is accepted, is sent to the server. In some cases, the selected MSP may request items such as, but not limited to, driver license, employer identification number (“EIN”) or copy of SS-4 form, social security card, profit and loss (“P&L”) statement, utility bill, and/or a voided business check.

### Steps 221-224

In step 221, the server receives the request for PII and confirmation of appointment acceptance and transmits the information to the merchant computing device. In step 222, the merchant computing device displays a message that the appointment is confirmed and that the MSP has requested PII. In step 223, an option to upload the requested PII is displayed on the merchant computing device. In step 224, the merchant selects the option to upload PII and subsequently uploads the requested information/documentation.

### Step 225

In step 225, the server receives and stores the uploaded PII and then sends notice to the MSP that the PII has been received. In order to secure PII (as well as other sensitive information), in some embodiments, the software may be integrated with homomorphic encryption technology to securely store and/or exchange sensitive data. Homomorphic encryption may allow customer data to remain in encrypted form, even if exposed to a person or third-party, by allowing computations to be carried out in an encrypted format without requiring the data to be decrypted at any point throughout the process. In certain embodiments, the software may also be integrated with blockchain technology to securely and incorruptibly track, record, and manage cyber transactions. For example, the software may be adapted, through the use of application programming interfaces (“APIs”), to send and receive funds in the form of cryptocurrency, such as, but not limited to, RIPPLE® XRP®, registered trademarks of Ripple Labs Inc. and Ox (also known as “ZRX”) cryptocurrencies. Other security protocols, such as vault and tokenization of PII, may also be enabled.

### Steps 226-229

In step 226, a message is displayed on the MSP computing device notifying the service provider that the merchant has uploaded the requested PII and an option to view and accept/deny the PII is also displayed. In step 227, the MSP selects the option to view the PII and subsequently selects the option to accept the PII; notice is sent to the server that the PII is accepted. In step 228, the server receives notice that the PII is accepted and the server sends notice to merchant that PII has been received and accepted by the MSP. In step 229, the merchant computing device displays a message confirming the receipt and acceptance of uploaded PII, along with message reconfirming appointment. In step 230, the merchant user then closes the application on their computing device.

### Additional Features

After a merchant has selected a new MSP, it is possible that, over time, a more favorable MSP may become available. For example, a merchant's business may grow and evolve over time, such that the types of transactions processed by their MSP changes which, as a result, may affect the rates and fees charged by the current MSP. Additionally, new MSPs may be introduced on the market who may have lower rates and/or fees. As a result, in some embodiments, the present invention may also serve as a MSP contract monitoring service.

As part of a contract monitoring service, periodic (e.g., semi-annually, annually, bi-annually, etc.) reviews may take place in which a current relationship is evaluated to ensure that a merchant retains the best, or most ideal, MSP to handle their business transactions. Contract monitoring may be performed, automatically or upon request, and may involve similar procedures as those outlined in FIG. 2. For example, every year from the date that a relationship is established, a review may occur which may involve calculating the current effective rate charged by the current MSP and comparing it to a projected effective rate charged by a potential MSP. In some embodiments, the effective rate charged by a current MSP may be calculated, periodically, to determine if, and how, the effective rate has changed over a period of time. If at any given point in time a more favorable MSP is identified, a merchant may be able to request an appointment and/or initiate contact with the potential MSP.

Though the foregoing exemplary processes illustrate pathways which are primarily based on a merchant user, some of the exemplary steps (and variations thereof) may also be applicable to MSP users. For example, to access the software, MSP users should download an application to their computing device and register an account. During registration, the MSP user may identify themselves as an MSP and the application may self-configure accordingly. Similar to the merchant user registration process, the MSP user may be prompted to provide financial and business information. This may include information such as, but not limited to, locale, contact information (e.g., website, phone number, email address, mailing address, etc.), customer base type, types of services offered, rates, fees, and terms. In some embodiments, financial data associated with an MSP may be manually populated by the user, or automatically populated via integration with one or more third-party platforms and/or databases. MSP user data may then be stored on a private or publicly accessible database for access by one or more software servers.

According to other embodiments of the present invention, the software described herein may serve as a database of information for users to access and make informed decisions therefrom. Furthermore, the software can integrate with, or utilize, third-party platforms and software to improve the functionality of the software. In some embodiments, the software may include artificial intelligence, machine learning, algorithms, and bots for purposes of growing a user's business and improving their experience with the software. In some aspects, the software may provide financial monitoring and payment processing services. For example, financial monitoring and payment processing services may be provided through payment gateways, software algorithms, and machine learning which can automate electronic forms of payment as financial acceptance, analytics, and data account exchange.

According to some embodiments, the software may be periodically updated using one or more bots in order to provide new, or expand existing, educational resources for merchants and/or to add or update third-party resources such as, but not limited to: industry schedules; merchant category code (“MCC”) listings; interchange listings and information, such as rates and fees; bank interest rates; and transactional tips for merchants and merchant staff to promote behavioral changes prior to sale and at the point of sale. In some embodiments, the software may also use AI and one or more bots to integrate with and retrieve information from business and financial news outlets. For example, the software may use one or more algorithms to mine local, regional, and global news outlets, then potentially relevant information may be extracted using AI and machine learning integrated with predictive software. The information then may be processed to determine its relevance and pertinence to a user of the software. Such information may include market changes, political impacts to the business and finance sector, and other relevant news stories and events on a global, regional, or local scale. In some embodiments, the software may include AI-based push notifications which may notify users of such events (as well as software-related events).

In some embodiments, the software may use imported or uploaded data to calculate the effective rate charged to a merchant by a merchant service provide for the purpose of setting a baseline average of fees charged by the MSP. For example, an algorithm may calculate the effective rate charged by an MSP for a set number of merchants, then the data may be averaged to establish a baseline effective rate for the specific MSP. The baseline (average) effective rate may then be provided by the software so that merchants can view and compare average effective rates across various MSPs.

In accordance with some embodiments, data collected via the software for merchant users and MSP sales professional may be aggregated and used in an artificial intelligence engine to offer cash advances, lines of credit, cryptocurrency conversions, and other financial and non-financial services to merchants. For example, data collected may be used to identify key phrases and commonly searched for words or phrases to determine a consumer's interest and need for various types of business services.

In some embodiments of the present invention, the software can be integrated with other related, or unrelated, platforms. This may include identifying customer-relationship management software (“CRM”), and other related software, and exchanging data therewith which can be used by a consumer. For example, pre-existing profiles may be extracted from social networking platforms and relevant information about an MSP account representative can be populated into a CRM system, such as SALESFORCE®, a registered trademark of salesforce.com, inc., customer-relationship management software. This feature may allow merchants to personalize or create a set of MSP account representatives (e.g., those within a user-selected or system-defined distance from the user), enhancing the user experience and creating a more informed buyer, or user of selected services. The software can also use APIs to integrate with other customer-relationship management platforms such as, but not limited to, HUBSPOT®, a registered trademark of HubSpot, Inc., ZENDESK®, a registered trademark of Zendesk, Inc., DELTEK℠, APPTIVO℠, FIVE9®, a registered trademark of Five9, Inc., INFUSIONSOFT®, a registered trademark of Infusion Software, Inc., ZOHO®, a registered trademark of Zoho Corporation Private Limited, MICROSOFT DYNAMICS®, a registered trademark of Microsoft Corporation, INFOR®, a registered trademark of Infor (US), Inc., ORACLE®, a registered trademark of Oracle International Corporation, COPPER℠, and NETSUITE®, a registered trademark of Netsuite Inc.

In some embodiments, the software may integrate credit repair, rebuild, and/or monitoring services, using coded language, which may be incorporated into personal and business financial profiles. For example, the software may be integrated with third-party outlets to help strengthen a merchant's credit—such outlets may include CREDIT KARMA®, a registered trademark of Credit Karma Corporation, EXPERIAN®, a registered trademark of Experian Information Solutions, Inc., NERDWALLET®, a registered trademark of Nerdwallet, Inc., MINT®, a registered trademark of Intuit Inc., CIGNIFI®, a registered trademark of Cignifi Inc., and QUIZZLE®, a registered trademark of Quizzle LLC. Such platforms may be integrated using coding and programming platforms, such as, but not limited to: JAVASCRIPT®, a registered trademark of Oracle America, Inc.; NODE.JS®, a registered trademark of Joyent, Inc.; REACT NATIVE™; PYTHON®, a registered trademark of Python Software Foundation; SWIFT®, a registered trademark of Society for Worldwide Interbank Financial Telecommunication SCRL; AWS®, a registered trademark of Amazon Technologies, Inc.; FIREBASE®, a registered trademark of Google LLC; and POSTGRESQL®, a registered trademark of PostgreSQL Community Association of Canada (also known as POSTGRES®, a registered trademark of PostgreSQL Community Association of Canada).

In some embodiments, software may be integrated with third-party investment tools which may allow a merchant to allocate a portion of their profits for investment and diversification purposes. Such tools may be integrated using coded language to translate and encrypt financial data exchanged between the software and third parties. In other embodiments, software may be integrated with, or embodied in, a suite or network of services including, but not limited to: financial advice and management; peer-to-peer lending; budgeting tools; personal and business insurance; cognitive AI; digital-only banking; regulations technology (regulations compliance) and Know Your Customer (“KYC”) checks using APIs; and bot and machine learning.

In some embodiments of the present invention, certain features may be integrated into the software to improve it over time. For example, artificial intelligence may be incorporated into a virtual assistant to provide tools, insight, and resources and to learn patterns of software users in order to provide actionable intelligence from a service perspective. In some embodiments, AI may also be combined with machine learning and incorporated into a virtual assistant to study, collect, and analyze data in order to suggest actionable insights from user data and provide new features and services based on direct feedback which may be entered, for example, via automated chat survey responses. Anticipated feedback for software improvements may include enhancements on a user interface, additional MSP features added to client offerings, financial services features to enhance cash flow management, and a merchant tips page offering industry insight to help guide merchants during sales solicitation and contract negotiations phase. Some embodiments may also use AI to track user interaction with one or more interface features, run AB test scenarios based on position of certain features, and thus determine based on actual usage data, optimal positioning. Some embodiments may discern focal points and duration of user eye focus on the interface to test receptivity of certain offers. In some embodiments, one or more bots may be used to automate software updates and improvements to the software and software features.

In some embodiments, tools may be provided to improve software user experience and grow user businesses. The software may also utilize a user device's geolocation to personalize the user experience by obtaining content specific to the user's area or region. For example, the software may allow access to industry cohort data for large populations of merchants, enabling merchants to benchmark their merchant account performance relative to similarly situated and sized merchants. In some embodiments, the software may include an algorithm to predict customer success and match recommended merchants with customers. For example, one or more algorithms may allow the software to monitor trends of business closures, success and failure rates, and other merchant and MSP metrics to predict customer success. The software may further include a feedback loop system, utilizing data from integrated CRM software, which automatically improves the algorithm as new data is acquired.

In some embodiments of the present invention, software may utilize machine learning to connect a merchant with other merchants for the purpose of networking. For example, the software may provide automated suggestions for merchants to cross-promote products and/or services within similar industries, based on data received from compatibility tools. In some embodiments, the software may also utilize machine learning to offer marketing tips and suggestions to merchants, which may aid in reaching existing and prospective customers.

In accordance with some embodiments of the present invention, software may utilize machine learning and one or more bots for marketing services, collection and/or calculation of statistics, industry trends, and development of strategies specific to a merchant's business, product, or service. This may be achieved using coded language and machine learning which can identify commonly used, or searched, words and phrases. For example, the software may help a merchant capture new business by providing tools and automated suggestions such as, but not limited to, social media integration, inbound marketing and website/media integration to streamline messaging from the merchant to its customer base, content repost and search engine ranking based on search algorithms (e.g., search engine optimization (“SEO”), blog writing, podcasts, video logs (or “vlogs”), etc.).

In some embodiments, software may use bot and machine learning to integrate and source extended business services. Services may be sourced from local and regional business within a user's area (based on geolocation) by cross-matching key words or phrases identifying a user's need or interest, then providing suggestions using a bot. For example. the software may integrate and source services such as, but not limited to: legal counsel; tax preparation; communal work space; painting; interior design; telecommunication and Wi-Fi technicians; human resources; and labor and employment services for staffing, such as accounting for employees, independent contracted services, and other services including freelance employment and externship programs (e.g., employment for college credit).

In some embodiments of the present invention, software may retrieve or extract data from a merchant's profile in order to build, or update, a business plan or model for the merchant. For example, the software may use the extracted data to analyze the merchant business' electronic “footprint” of media, advertising, marketing, financials, and other outlets to establish a business model and plan which can then be used to seek funding and/or pair the merchant with inventors and venture capital firms.

In some embodiments of the present invention, software may use one or more bots to source, pair, and/or update matches with commercial realtors for merchants who may be franchisees or single/multi-locational businesses looking to grow and expand. Additionally, the software may match a merchant with, or suggest, businesses which provide various services, such as, but not limited to, general contracting, appraisal, electrician, pest control, and plumbing services. This may include identifying the nature of a merchant user's business and matching them with other merchant user business within a similar industry. Alternatively, business data may be sourced from public records, such as a register of businesses within a county. In certain embodiments, the software may provide county and city zoning provisions, permits, and other important information, documents, and forms to help ensure merchant compliance.

In accordance with some embodiments of the present invention, software may store any and all data provided in-software, with capability to track MSP production, conversion, reporting, notes, analysis and trends which may be accessed through a dashboard and housed in the software database. For these purposes, in some embodiments, the present invention may function as processing and/or monitoring service. In some embodiments, data uploaded, downloaded, exchanged, and stored on secured servers may be used to competitively and aggressively offer merchant users the best merchant service processing. “Best,” in some embodiments, may be defined based on one or more user-defined criteria, which may be quantitative, qualitative, or binary in nature (service available or not available for example). Exemplary collected data may include early termination fee (“ETF”) buyout, discounted or rented terminal and point-of-sale (sometimes referred herein as “POS”) solutions, merchant fee waivers, cash discounts, guaranteed rates based on set terms of length, referral fees based on recommended new businesses, statement account credits for new businesses, and career opportunities for merchant or MSP personnel looking for additional income as an affiliate relationship or interested in finding new sales positions. Stored data on software servers can also be used for lead generation purposes.

In some embodiments, a merchant may have contracts with two or more MSPs and the software, or backend server software, may monitor initiated transactions at a POS terminal (virtual or real) and determine, based on the given transaction and the contract terms for each MSP, the most effective MSP for processing the transaction. Monitoring may also be done on a scheduled basis, for example, hourly, daily, weekly, or monthly. In some embodiments, one or more transactions completed via one MSP may be cancelled and instead completed through another MSP. In some embodiments, a purchasable subscription service may be available for monitoring the MSP marketplace as a buyer's agent for the merchants searching for better terms and conditions than those currently being utilized by merchants.

In some embodiments of the present invention, software may be adapted to be integrated with an individual or business bank account by means of one or more APIs. Using coded language and granted access of financial data by a user, the software may automate data exchange across platforms. By means of one or more APIs, the software may track merchant debits and credits from a payment processor over a period of time (e.g., on a monthly basis), which may allow the software to track trends in merchant fees. Based on trends in merchant fees, the software may use one or more reporting tools, such as automated messages, notifications, and/or suggestions, by which a merchant can be made aware of such trends.

In some embodiments, software may be adapted to track usage and allocation of a user's funds. For example, the software may utilize an algorithm which can calculate statistics and metrics related to the use or allocation of profits. In certain embodiments, the algorithm may be used to calculate the percentage of profits allocated to a particular type of account. For example, the algorithm may calculate the percentage of a merchant's profits that have been allocated to an emergency fund (i.e., for emergency or unexpected expenses), an educational or large purchase savings account (i.e., for educational expenses, or other large purchases, for family members), and/or a grant account (i.e., for awarding funds to employees for tuition, home or auto purchases, vacation, etc.).

According to some embodiments of the present invention, software may utilize one or more bots to establish a review system. For example, service provider rankings may be calculated or determined based on merchant feedback, testimonials, and/or completed surveys. In some embodiments the review system may comprise a modified subset of Naive Bayes algorithms in order to provide accurate rolling/weighted ratings for merchant processor accounts.

### Exemplary System for Implementing Software

According to some embodiments of the present invention, software processes and functions may be implemented via a network of servers, databases, and computing devices. For example, as illustrated in FIG. 5, system network 3000 may include database 3100, server 3200, merchant computing device 3300, and MSP computing device 3400. Database 3100 may comprise publicly available information which can be integrated into the software, such as, but not limited to, information from third-party financial platforms, government registries (e.g., Standard Industrial Classification (“SIC”) codes), and web analytics tools. In some embodiments, one or more databases may include publicly and/or privately available data on MSPs, such as addresses, special offers, fees, etc.

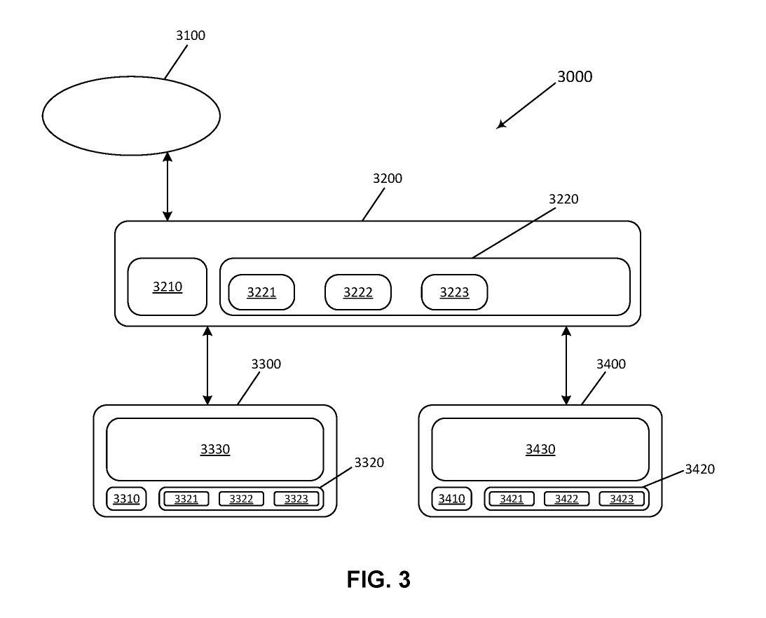

In some embodiments, a database may take the exemplary form of one or more electronic, magnetic, or optical data storage devices, coupled with one or more servers. For example, as further illustrated in FIG. 3, database 3100 may be coupled with server 3200, enabling the exchange of data from database 3100 to merchant computing device 3300 and MSP computing device 3400 via, for example, an application program interface, or electronic data interchange, or any other way of communicating data. Server 3200 may serve webpages or other markup language forms with associated applets, remote-invocation objects, or other related software and data structures to service data clients of various “thicknesses” (that is, capabilities), including downloading, updating, and/or communicating with an operating system of an access device, and other types of software.

As further illustrated in FIG. 3, server 3200 may include processor 3210 for reading and executing machine-readable data. It is to be appreciated that the term “processor” may refer to one or more local or distributed processors, controllers, or virtual machines. In the exemplary embodiment, processor 3210 may assume any form.

Server 3200 may also include memory device 3220 for storing data received from database 3100 or computing device 3300. In some embodiments, a memory device may take the form of one or more non-transient electronic, magnetic, or optical data storage devices. Memory device 3220 may store user database portion 3221, merchant portion 3222, and MSP portion 3223.

User data module 3221 may include user-related data and machine-executable instructions sets for controlling, administering, and managing user accounts and related activities conducted through system network 3000. In addition to one or more application program interfaces (not shown) for accessing one or more external databases, or portions thereof, associated with or accessible to specific users, a user data module may include user data structures comprising various types of data related to user identification. For example, user data module 3221 may include account related information, such as, but not limited to, user name, password, name, address, organizational identifier(s), credit card or other billing account information, access credentials, usage history, and access plans and permissions for various software functions and features.

Merchant module 3222 may include data and machine-executable instructions for retrieving data from database 3100 and implementing one or more merchant-related functions described herein. For example, merchant module 3222 may include information related to a relationship between a merchant and their current MSP, which may be used in a process of determining, or identifying, one or more potential MSPs. Such utilized information may include, for example, the current effective rate charged by the current MSP and location information associated with the merchant.

MSP module 3223 may include data and machine-executable instructions for retrieving data regarding MSPs and implementing one or more MSP-related functions described herein. For example, MSP module 3223 may include information related to a potential MSP which may be used in a process of identifying the potential MSP to a merchant. Such utilized information may include an identification of an MSP account representative, location information associated with the MSP, and one or more contract terms associated with the MSP.

A computing device may be generally representative of one or more types of computing devices. For example, merchant computing device 3300 and MSP computing device 3400 may take the form of a personal computer, smartphone, tablet, or any other device capable of interfacing with a server or database. Merchant computing device 3300 may include processor 3310, memory device 3320, and merchant user interface 3220. Likewise, MSP computing device 3400 may include processor 3410, memory device 3420, and MSP user interface 3420. In some embodiments, a user interface may include a touch screen display, text-to-speech capability, as well as GPS or other types of location capabilities.

Processors 3310 and 3410, which may each be representative of one or more processors, processing circuits, or controllers, may be coupled with memory devices 3320 and 3420, respectively. Memory devices 3320 and 3420 can store code (machine-readable or executable instructions) for an operating system, a browser, and a graphical user interface (sometimes referred herein as “GUI”) (which may be defined in whole or part by various modules within server 3200). In an exemplary embodiment, an operating system and browser may support rendering of a GUI on user interfaces 3330 and 3430. Upon rendering, a GUI may present wander event or sensor data in association with one or more interactive control features (or user-interface elements). In an exemplary embodiment, one or more control features may take the form of a hyperlink or other browser-compatible command input, and may provide access to, and control of, various regions of the graphical user interfaces described herein.

In the foregoing specification, exemplary embodiments have been described. However, one of ordinary skill in the art would appreciate that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover in this document, relational terms, such as second, top and bottom, and the like may be used solely to distinguish one entity or action from another entity or action without necessarily requiring or implying any actual such relationship or order between such entities or actions. The terms “comprises”, “comprising”, “has”, “having,” “includes”, “including”, “contains”, “containing”, or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises a”, “has . . . a”, “includes . . . a”, “contains . . . a” does not, without more constraints, preclude the existence of additional elements of the same type in the process, method, article, or apparatus that comprises, has, includes, contains the element. The terms “a” and “an” are defined as one or more unless explicitly stated otherwise herein. The terms “substantially”, “essentially”, “approximately”, “about”, or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. Also, the term “exemplary” is used as an adjective herein to modify one or more nouns, such as embodiment, system, method, device, and is meant to indicate specifically that the noun is provided as a non-limiting example.

In some embodiments, one or more of the operations, methods, and functionality described above or portions thereof are integrated in a manner to improve the functioning of a computer system or portion of.

What is claimed is:

1. A method for facilitating relationships between merchants and merchant services providers comprising the steps of:
a) receiving information about a current relationship between a merchant and a current merchant services provider;
b) characterizing said current relationship, wherein said step of characterizing said current relationship comprises computing a current effective rate from said information about said current relationship;
c) receiving information about a potential relationship between said merchant and a potential merchant services provider;
d) characterizing said potential relationship between said merchant and said potential merchant services provider, wherein said step of characterizing said potential relationship comprises computing a potential effective rate from said information about said potential relationship;
e) comparing said current relationship and said potential relationship, wherein said step of comparing said current relationship and said potential relationship comprises comparing said current effective rate and said potential effective rate; and
f) if said potential effective rate is lower than said current effective rate, providing a recommendation to said merchant to contact said potential merchant services provider and facilitating an initial communication between said merchant and said potential merchant services provider.

2. The method of claim 1, wherein said information received about said current relationship comprises at least one term of a contract between said merchant and said current merchant services provider, wherein said at least one term comprises of one of the group consisting of processing fees charged, processing rates charged, service fees charged, and interchange fees charged, and combinations thereof.

3. The method of claim 1, wherein said information received about said current relationship comprises transactional use data from at least one statement issued by said current merchant services provider to said merchant, wherein said transactional use data comprises one of the group consisting of payment transactions by payment card type, third-party transactions, chargebacks, reversals, adjustments, fees charged, amount funded, average ticket by payment card type, and pending charges, and combinations thereof.

4. The method of claim 3, wherein said step of characterizing said current relationship comprises computing at least one use metric from said transactional use data, wherein said at least one use metric comprises one of the group consisting of an effective rate, average ticket amount by payment card type, total amount of fees charged, and total amount of pending charges and fees, and combinations thereof.

5. The method of claim 1, wherein said information received about said potential relationship comprises at least one term of a potential contract between said merchant and said potential merchant services provider, wherein said at least one term comprises of one of the group consisting of processing fees, processing rates, service fees, and interchange fees, and combinations thereof.

6. A computer implemented method for operating one or more servers to establish a communication with a merchant comprising:
a) maintaining a merchant services provider database in a memory resource associated with said servers, wherein said merchant services provider database comprises a plurality of entries, each said entry corresponding to one of a plurality of potential merchant services providers and comprising:
(i) an identification of said corresponding potential merchant services provider,
(ii) an identification of a representative of said corresponding potential merchant services provider,
(iii) an identification of a geographic area associated with said corresponding potential merchant services provider, and
(iv) at least one term of a contract offered by said corresponding potential merchant services provider;
b) receiving from a merchant application executing on a computing device of said merchant:
(i) information about a relationship between said merchant and a current merchant services provider, and
(ii) a location associated with said merchant;
c) computing a current effective rate from said current merchant services provider relationship information;
d) generating a candidate list of potential merchant services providers from said merchant services provider database;
e) providing data to said merchant application to generate a presentation on a display of said merchant computing device, said presentation comprising said candidate list;
f) receiving from said merchant application a request to establish a communication with a selected potential merchant services provider from said candidate list;
g) providing data to a merchant services provider application executing on a computing device of said representative of said selected potential merchant services provider to generate a presentation on a display of said representative computing device, said presentation comprising said request to establish said communication with said merchant; and
h) receiving data from said merchant services provider application comprising an acceptance of said request to establish said communication with said merchant.

7. The method of claim 6, wherein said step of receiving from said merchant application said information about said current merchant services provider relationship comprises receiving at least one image based on data determined by said merchant application executing to interface with a camera resource of said merchant computing device.

8. The method of claim 7, wherein said at least one image corresponds to a statement issued by said current merchant services provider, further comprising the step of processing said at least one image to extract transactional use data therefrom.

9. The method of claim 8, wherein said transactional use data comprises one of the group consisting of payment transactions by payment card type, third-party transactions, chargebacks, reversals, adjustments, fees charged, amount funded, average ticket by payment card type, and pending charges, and combinations thereof.

10. The method of claim 9, wherein said current effective rate is computed from said transactional use data.

11. The method of claim 6, wherein said step of receiving from said merchant application said information about said current merchant services provider relationship comprises receiving at least one contract term of a contract between said merchant and said current merchant services provider based on a form generated by said merchant application.

12. The method of claim 11, wherein said contract term comprises one of the group consisting of processing fees charged, processing rates charged, service fees charged, and interchange fees charged, and combinations thereof.

13. The method of claim 11, wherein said current effective rate is computed from said at least one contract term.

14. The method of claim 6, wherein said step of receiving from said merchant application said location information comprises receiving the current location of said merchant computing device, based on data determined by the merchant application executing to interface with a Global Positioning System resource of said merchant computing device.

15. The method of claim 6, wherein said step of receiving from said merchant application said location information comprises receiving said location based on a form generated by said merchant application.

16. The method of claim 6, wherein said step of receiving from said merchant application said location information comprises receiving a location radius based on a form generated by said merchant application.

17. The method of claim 6, wherein said step of generating said candidate list comprises the steps of:
(i) determining which of said potential merchant services providers have a geographic area which encompasses said location associated with said merchant;
(ii) computing a potential effective rate for at least one of said potential merchant services providers; and
(iii) determining which of said potential merchant services providers have a potential effective rate which is less than said current effective rate.

18. The method of claim 17, wherein said step of computing said potential effective rate comprises the steps of:
(i) processing at least one image received by said merchant application, said at least one image based on data determined by said merchant application executing to interface with a camera resource of said merchant computing device, to extract transactional use data; and
(ii) computing said potential effective rate from said transactional use data and said at least one term of said contract offered by said potential merchant services provider.

19. The method of claim 6, further comprising the steps of:
i) providing data to said merchant application to generate a presentation on a display of said merchant computing device, said presentation comprising a list of times that said communication may be established;
j) receiving from said merchant application a selected communication time;
k) providing data to said merchant services provider application to generate a presentation on a display of said representative computing device, said presentation comprising said selected communication time;
l) receiving from said merchant services provider application an acceptance of said selected communication time; and
m) providing data to said merchant application confirming said selected communication time.

20. The method of claim 19, further comprising the steps of:
n) providing data to said merchant application to create an entry in a calendar application executing on said merchant computing device; and
o) providing data to said merchant services provider application to create an entry in a calendar application executing on said representative computing device.

21. The method of claim 19, further comprising the steps of:
n) providing data to said merchant application to generate a presentation on a display of said merchant computing device, said display comprising a chat box; and
o) providing data to said merchant services provider to generate a presentation on a display of said representative computing device, said display comprising a chat box.

22. The method of claim 21, further comprising the steps of:
p) receiving data from said merchant application and providing said data to said merchant services provider application, said data comprising a message from said merchant to said merchant services provider representative; and
q) receiving data from said merchant services provider application and providing said data to said merchant application, said data comprising a message from said merchant services provider representative to said merchant.

23. A merchant services provider contract monitoring service system, wherein said system comprises one or more processors coupled to a non-transient storage media storing instructions for causing one or more processors to:
a) receiving current relationship data from a merchant application executing on a computing device of a merchant, said data comprising information about a relationship between said merchant and a current merchant services provider;
b) analyzing said current relationship data received by said merchant application to compute a current effective rate, wherein said current effective rate comprises a ratio of the dollar amount assessed by said current merchant services provider to the dollar amount of transactions submitted for processing;
c) simulating a potential relationship between said merchant and a potential merchant services provider, said step of simulating said potential relationship comprising computing a potential effective rate from said current relationship data and one or more terms of a contract offered by said potential merchant services provider;
d) comparing said current effective rate and said potential effective rate; and
e) if said potential effective rate is less than said current effective rate, establishing a communication between said merchant computing device and a representative computing device of a representative of said potential merchant services provider.

24. The system of claim 23, wherein said step of receiving current relationship data comprises:
(i) receiving at least one image based on data determined by said merchant application executing to interface with a camera resource of said merchant computing device; and
(ii) processing said at least one image to extract transactional use data therefrom.

25. The system of claim 23, wherein said step of establishing said communication comprises the steps of:
(i) first, providing data to said merchant application, said data comprising said potential effective rate and an identification of said potential merchant services provider;
(ii) then, receiving data from said merchant application, said data comprising a request to establish said communication between said merchant and said potential merchant services provider;
(iii) then, providing data to a merchant services provider application executing on a computing device of a representative of said potential merchant services provider, said data comprising a request to accept said request to establish said communication;
(iv) then, receiving data from said merchant services provider application, said data comprising an acceptance of said request to accept said request to establish said communication; and
(v) then, providing data to said merchant application, said data comprising an acceptance of said request to establish said communication.

26. The system of claim 23, wherein said step of establishing said communication comprises receiving from and providing data to each said merchant application and said merchant services provider application, said data comprising (i) messages received by said merchant application executing to interface with a merchant user input of said merchant computing device and (ii) messages received by said merchant services provider application executing to interface with a merchant services provider user input of said representative computing device.
